(19) United States
(12) Patent Application Publication
(10) Pub. No.: US 2025/0224989 A1
(43) Pub. Date: Jul. 10, 2025

(54) METHOD AND SYSTEM FOR OPTIMAL PLACEMENT OF TRANSFORMER MODEL BLOCKS ACROSS WORKER NODES

(71) Applicant: Tata Consultancy Services Limited, Mumbai (IN)

(72) Inventors: SHRUTI KUNAL KUNDE, Thane (IN); RAVI KUMAR SINGH, Thane (IN); MAYANK MISHRA, Thane (IN); REKHA SINGHAL, Thane (IN); LIKHITH YADAV BANDAMUDI, Thane (IN)

(73) Assignee: Tata Consultancy Services Limited, Mumbai (IN)

(21) Appl. No.: 19/004,562

(22) Filed: Dec. 30, 2024

(30) Foreign Application Priority Data
Jan. 4, 2024 (IN) 202421000725

(51) Int. Cl. G06F 9/50

(52) U.S. Cl. CPC G06F 9/5027; G06F 9/5016

(57) ABSTRACT

Existing approaches for distributing data processing across nodes in a distributed computing environment, based on left over memory with each node, have the disadvantage that they require block placement to be done by a user. Embodiments disclosed herein provide a method and system for optimal placement of transformer model blocks across worker nodes. The system determines left over memory at each of a plurality of worker nodes. Further, based on the left over memory and size of transformer model blocks, the system prioritizes the worker nodes, and accordingly allocates the transformer blocks across the worker nodes.

### PRIORITY CLAIM

This U.S. patent application claims priority under 35 U.S.C. § 119 to: Indian Patent Application number 202421000725, filed on Jan. 4, 2024. The entire contents of the aforementioned application are incorporated herein by reference.

### TECHNICAL FIELD

The disclosure herein generally relates to resource sharing, and, more particularly, to method and system for optimal placement of transformer model blocks across worker nodes.

### BACKGROUND

Artificial Intelligence (AI) data models have become pervasive, finding widespread applications in businesses, such as natural language processing and recommender systems for inference tasks. The AI data model may be a Generative AI model such as but not limited to Large Language Models (LLM), or any other type of AI data model. Such data models find widespread applications across domains. For example, LLMs have been instrumental in enabling decision-making and in facilitating various aspects of day-to-day business operations in enterprises. With the continuous evolution of LLMs, a notable challenge which has emerged is their increasing size. As LLMs grow in scale, they require a substantial amount of memory and compute resources for effective deployment. These requirements may pose a constraint in enterprises having limited infrastructure, impeding their ability to fully leverage the potential of LLMs for inference tasks.

Many businesses deploy LLM-powered chatbots for customer support. These chatbots require substantial memory and computational resources for handling natural language queries efficiently. Recommender systems powered by LLMs, like those used by streaming services, need to process vast amounts of user data and perform complex language-based recommendations, demanding considerable computational resources. Besides LLMs have been steadily increasing in size over time to improve their performance, and this growth has led to greater resource requirements.

LLMs generally require more memory and computational power for efficient inference. As businesses grow and their workloads increase, they may find it challenging to scale their inferencing infrastructure to meet the demand. This can lead to performance bottlenecks and delays. To address these challenges enterprises do have multiple options such as leveraging cloud-based LLM services to help mitigate some of the infrastructure and resource constraints. Cloud providers offer pre-configured LLM models and scalable infrastructure, which may not necessarily be a cost-effective solution. This is true for other types of AI models as well, which require large amount of data for training, and in turn require large amounts of resources for training.

Some of the existing approaches addressing the resource requirements in this context use distributed processing and resource sharing to tackle this challenge. In this approach, processing load is shared between different nodes (alternately termed as ‘worker nodes’), especially when some or all of the nodes do not use whole of the available processing capacity. One of the existing approaches in the domain of distributed data processing enables distribution of transformer blocks across multiple workers for fine-tuning or inference, and uses left-over capacity from the workers in a cluster for enabling distribution of transformer blocks across worker nodes. However, a disadvantage of this approach is that manual intervention is required in deciding how different blocks of a transformer model are to be distributed across different nodes, i.e., a human is required to decide how the distribution should be, consequently leading to a non-optimal placement of blocks. This may also lead to sub-optimal system performance in terms of inference latency.

### SUMMARY

Embodiments of the present disclosure present technological improvements as solutions to one or more of the above-mentioned technical problems recognized by the inventors in conventional systems. For example, in one embodiment, A processor implemented method is provided. The method includes: collecting an input data comprising a) size of a plurality of transformer model blocks to be distributed across a plurality of worker nodes, b) information on the plurality of worker nodes available for servicing data in the plurality of transformer blocks, c) available memory with each of the plurality of worker nodes, d) available cores with each of the plurality of worker nodes, e) number of blocks on each of the plurality of worker nodes, and f) a current overhead on each of the plurality of worker nodes; determining a left-over memory capacity of each of the plurality of worker nodes; determining a preference score for the memory and cores in each of the plurality of worker nodes; generating a consistent comparison matrix comprising normalized values of the preference score of the memory and cores in each of the plurality of worker nodes; determining a weighted average of the memory and cores in each of the plurality of worker nodes, using data in the consistent comparison matrix; determining a final weighted average score for each of the plurality of worker nodes, wherein the final weighted average score represents availability of each of the plurality of worker nodes for processing the data to be processed; and allocating the plurality of transformer model blocks to one or more of the plurality of worker nodes, by prioritizing each of the plurality of worker nodes based on the final weighted average score.

In an embodiment of the method, the left-over memory capacity is determined based on the available memory and the current overhead.

In an embodiment of the method, the final weighted average score of each of the plurality of worker nodes is determined as:

[WScorei]←(Wm×LM(Si))+(Wci×AC(Si)), wherein,
WScorei is the final weighted average score, Wm is a weighted memory score, LM(Si) is the left-over memory capacity, Wci is a weighted core score, and AC(Si) is the number of available cores, for ith worker node of the plurality of worker nodes.

In an embodiment of the method, allocating the plurality of transformer model blocks to one or more of the plurality of worker nodes includes: determining number of blocks in the transformer model, to be loaded to each of the plurality of worker nodes, based on a) the left-over memory capacity of each of the plurality of worker nodes, and b) size of each of the blocks of the data to be processed; and loading the determined number of blocks to each of the plurality of worker nodes.

In another embodiment, a system is provided. The system includes one or more hardware processors, a communication interface, and a memory storing a plurality of instructions. The plurality of instructions cause the one or more hardware processors to: collect an input data comprising a) size of a plurality of transformer model blocks to be distributed across a plurality of worker nodes, b) information on the plurality of worker nodes available for servicing data in the plurality of transformer blocks, c) available memory with each of the plurality of worker nodes, d) available cores with each of the plurality of worker nodes, e) number of blocks on each of the plurality of worker nodes, and f) a current overhead on each of the plurality of worker nodes; determine a left-over memory capacity of each of the plurality of worker nodes; determine a preference score for the memory and cores in each of the plurality of worker nodes; generate a consistent comparison matrix comprising normalized values of the preference score of the memory and cores in each of the plurality of worker nodes; determine a weighted average of the memory and cores in each of the plurality of worker nodes, using data in the consistent comparison matrix; determine a final weighted average score for each of the plurality of worker nodes, wherein the final weighted average score represents availability of each of the plurality of worker nodes for processing the data to be processed; and allocate the data to be processed to one or more of the plurality of worker nodes, by prioritizing each of the plurality of worker nodes based on the final weighted average score.

In an embodiment of the system, the one or more hardware processors are configured to determine the left-over memory capacity is determined based on the available memory and the current overhead.

In an embodiment of the system, the one or more hardware processors are configured to determine the final weighted average score of each of the plurality of worker nodes as:

[WScorei]←(Wm×LM(Si))+(Wci×AC(Si)), wherein,
WScorei is the final weighted average score, Wm is a weighted memory score, LM(Si) is the left-over memory capacity, Wci is a weighted core score, and AC(Si) is the number of available cores, for ith worker node of the plurality of worker nodes.

In an embodiment of the system, the one or more hardware processors are configured to allocate the plurality of transformer model blocks, to one or more of the plurality of worker nodes, by: determining number of blocks in the transformer model, to be loaded to each of the plurality of worker nodes, based on a) the left-over memory capacity of each of the plurality of worker nodes, and b) size of each of the blocks of the data to be processed; and loading the determined number of blocks to each of the plurality of worker nodes.

In yet another aspect, a non-transitory computer readable medium is provided. The non-transitory computer readable medium includes a plurality of instructions, which when executed, cause one or more hardware processors to: collect an input data comprising a) size of a plurality of transformer model blocks to be distributed across a plurality of worker nodes, b) information on the plurality of worker nodes available for servicing data in the plurality of transformer blocks, c) available memory with each of the plurality of worker nodes, d) available cores with each of the plurality of worker nodes, e) number of blocks on each of the plurality of worker nodes, and f) a current overhead on each of the plurality of worker nodes; determine a left-over memory capacity of each of the plurality of worker nodes; determine a preference score for the memory and cores in each of the plurality of worker nodes; generate a consistent comparison matrix comprising normalized values of the preference score of the memory and cores in each of the plurality of worker nodes; determine a weighted average of the memory and cores in each of the plurality of worker nodes, using data in the consistent comparison matrix; determine a final weighted average score for each of the plurality of worker nodes, wherein the final weighted average score represents availability of each of the plurality of worker nodes for processing the data to be processed; and allocate the data to be processed to one or more of the plurality of worker nodes, by prioritizing each of the plurality of worker nodes based on the final weighted average score.

In an embodiment of the non-transitory computer readable medium, the one or more hardware processors are configured to determine the left-over memory capacity is determined based on the available memory and the current overhead.

In an embodiment of the non-transitory computer readable medium, the one or more hardware processors are configured to determine the final weighted average score of each of the plurality of worker nodes as:

[WScorei]←(Wm×LM(Si))+(Wci×AC(Si)), wherein,
WScorei is the final weighted average score, Wm is a weighted memory score, LM(Si) is the left-over memory capacity, Wci is a weighted core score, and AC(Si) is the number of available cores, for ith worker node of the plurality of worker nodes.

In an embodiment of the non-transitory computer readable medium, the one or more hardware processors are configured to allocate the plurality of transformer model blocks, to one or more of the plurality of worker nodes, by: determining number of blocks in the transformer model, to be loaded to each of the plurality of worker nodes, based on a) the left-over memory capacity of each of the plurality of worker nodes, and b) size of each of the blocks of the data to be processed; and loading the determined number of blocks to each of the plurality of worker nodes. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for optimal placement of blocks across worker nodes in a distributed computing environment, according to some embodiments of the present disclosure.

FIG. 2 is a functional block diagram of the system of FIG. 1, according to some embodiments of the present disclosure.

FIG. 3 is a flow diagram depicting steps involved in the process of the optimal placement of blocks across worker nodes in the distributed computing environment, using the system of FIG. 1, in accordance with some embodiments of the present disclosure.

FIGS. 4A, 4B, 4C, 4D, 4E, and 4F (collectively referred to as FIG. 4) depict graphs with example values associated with the optimal placement of blocks across worker nodes in the distributed computing environment, using the system of FIG. 1, according to some embodiments of the present disclosure.

FIGS. 5A, 5B, 50, 5D, 5E, and 5F (collectively referred to as FIG. 5) depicts graphs with example values of block execution times for 1, 2, and 4 concurrent clients in the distributed computing environment, using the system of FIG. 1, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

Some of the existing approaches addressing the resource requirements in this context use distributed processing and resource sharing to tackle this challenge. In this approach, processing load is shared between different nodes (alternately termed as ‘worker nodes’), especially when some or all of the nodes do not use whole of the available processing capacity. One of the existing approaches in the domain of distributed data processing enables distribution of transformer blocks across multiple workers for fine-tuning or inference, and uses left-over capacity from the workers in a cluster for enabling distribution of transformer blocks across worker nodes. However, a disadvantage of this approach is that manual intervention is required in deciding how different blocks of a transformer model are to be distributed across different nodes, i.e., a human is required to decide how the distribution should be, consequently leading to a non-optimal placement of blocks. This may also lead to sub-optimal system performance in terms of inference latency.

In order to address these challenges, embodiments disclosed herein provide a method and system for optimal placement of blocks across worker nodes in the distributed computing environment. The method includes: collecting an input data comprising a) size of a plurality of transformer model blocks to be distributed across a plurality of worker nodes, b) information on the plurality of worker nodes available for servicing data in the plurality of transformer blocks, c) available memory with each of the plurality of worker nodes, d) available cores with each of the plurality of worker nodes, e) number of blocks on each of the plurality of worker nodes, and f) a current overhead on each of the plurality of worker nodes; determining a left-over memory capacity of each of the plurality of worker nodes; determining a preference score for the memory and cores in each of the plurality of worker nodes; generating a consistent comparison matrix comprising normalized values of the preference score of the memory and cores in each of the plurality of worker nodes; determining a weighted average of the memory and cores in each of the plurality of worker nodes, using data in the consistent comparison matrix; determining a final weighted average score for each of the plurality of worker nodes, wherein the final weighted average score represents availability of each of the plurality of worker nodes for processing the data to be processed; and allocating the plurality of transformer model blocks to one or more of the plurality of worker nodes, by prioritizing each of the plurality of worker nodes based on the final weighted average score. This approach addresses the aforementioned challenge of a user having to manually take decisions with respect to placement of blocks across the worker nodes. The system facilitates the optimal placement of blocks by taking into consideration left over memory in each of the nodes and size of blocks to be distributed.

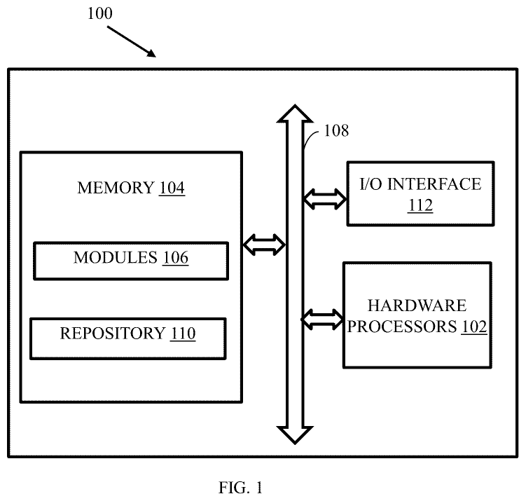

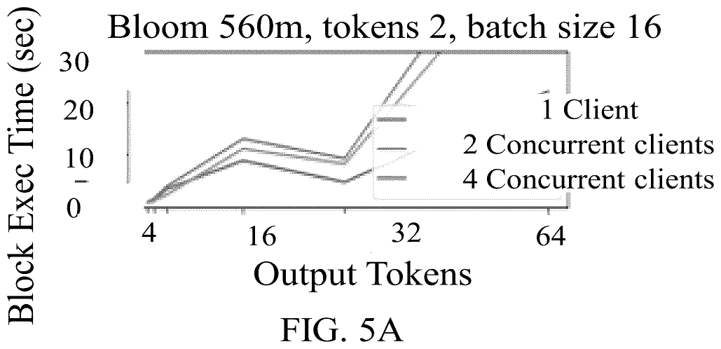

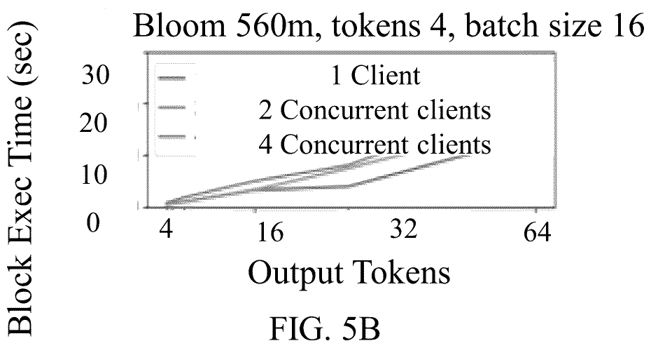

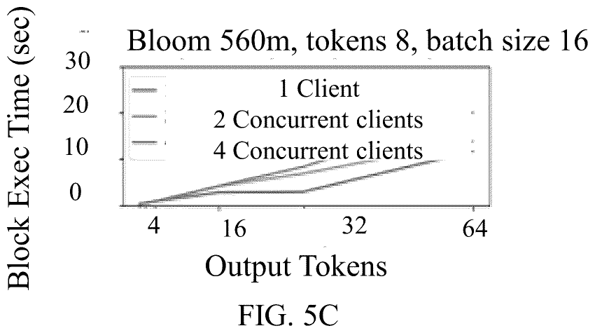

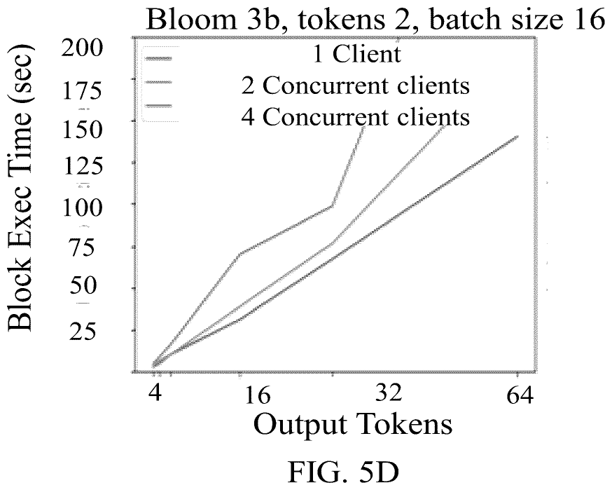

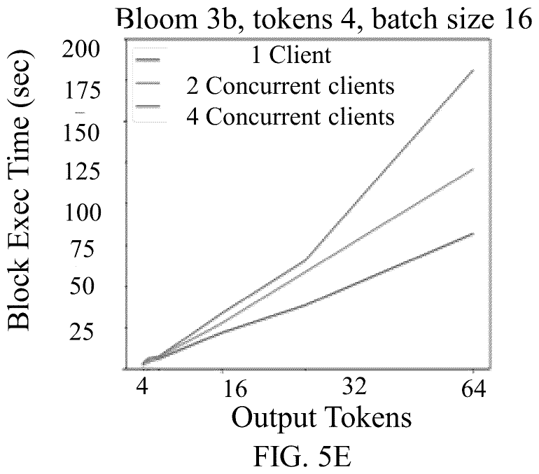

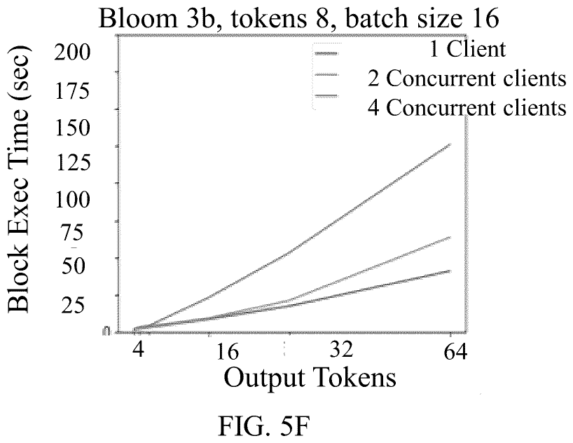

Referring now to the drawings, and more particularly to FIG. 1 through FIG. 5F, where similar reference characters denote corresponding features consistently throughout the figures, there are shown preferred embodiments and these embodiments are described in the context of the following exemplary system and/or method.

FIG. 1 illustrates an exemplary system for optimal placement of blocks across worker nodes in a distributed computing environment, according to some embodiments of the present disclosure.

The system 100 includes or is otherwise in communication with hardware processors 102, at least one memory such as a memory 104, an I/O interface 112. The hardware processors 102, memory 104, and the Input/Output (I/O) interface 112 may be coupled by a system bus such as a system bus 108 or a similar mechanism. In an embodiment, the hardware processors 102 can be one or more hardware processors.

The I/O interface 112 may include a variety of software and

hardware interfaces, for example, a web interface, a graphical user interface, and the like. The I/O interface 112 may include a variety of software and hardware interfaces, for example, interfaces for peripheral device(s), such as a keyboard, a mouse, an external memory, a printer and the like. Further, the I/O interface 112 may enable the system 100 to communicate with other devices, such as web servers, and external databases.

The I/O interface 112 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface 112 may include one or more ports for connecting several computing systems with one another or to another server computer. The I/O interface 112 may include one or more ports for connecting several devices to one another or to another server.

The one or more hardware processors 102 may be implemented as one or more microprocessors, microcomputers, microcontrollers, digital signal processors, central processing units, node machines, logic circuitries, and/or any devices that manipulate signals based on operational instructions. Among other capabilities, the one or more hardware processors 102 is configured to fetch and execute computer-readable instructions stored in the memory 104.

The memory 104 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. In an embodiment, the memory 104 includes a plurality of modules 106.

The plurality of modules 106 include programs or coded instructions that supplement applications or functions performed by the system 100 for executing different steps involved in the process of optimal placement of blocks across worker nodes in a distributed computing environment. The plurality of modules 106, amongst other things, can include routines, programs, objects, components, and data structures, which performs particular tasks or implement particular abstract data types. The plurality of modules 106 may also be used as, signal processor(s), node machine(s), logic circuitries, and/or any other device or component that manipulates signals based on operational instructions. Further, the plurality of modules 106 can be used by hardware, by computer-readable instructions executed by the one or more hardware processors 102, or by a combination thereof. The plurality of modules 106 can include various sub-modules (not shown). The plurality of modules 106 may include computer-readable instructions that supplement applications or functions performed by the system 100 for the optimal placement of blocks across worker nodes in a distributed computing environment.

The data repository (or repository) 110 may include a plurality of abstracted piece of code for refinement and data that is processed, received, or generated as a result of the execution of the plurality of modules in the module(s) 106.

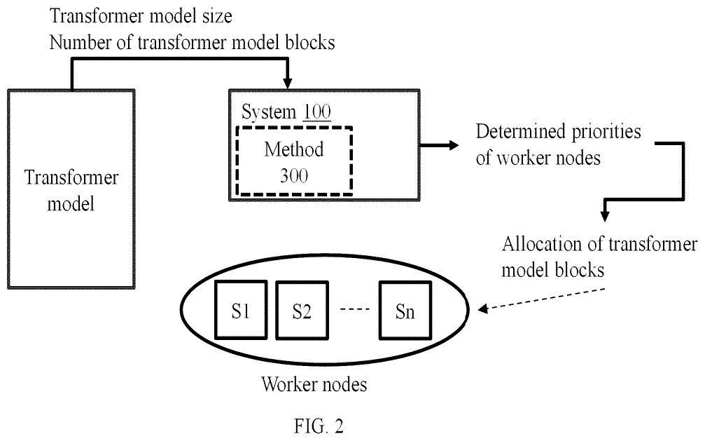

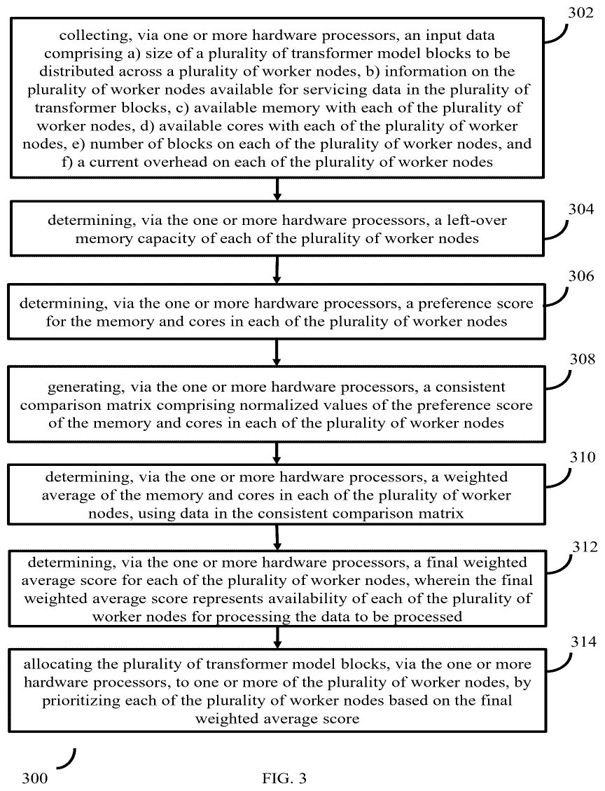

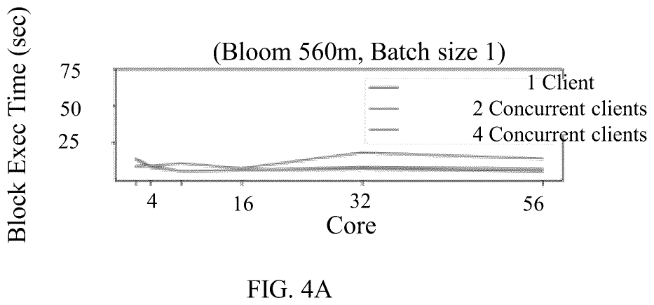

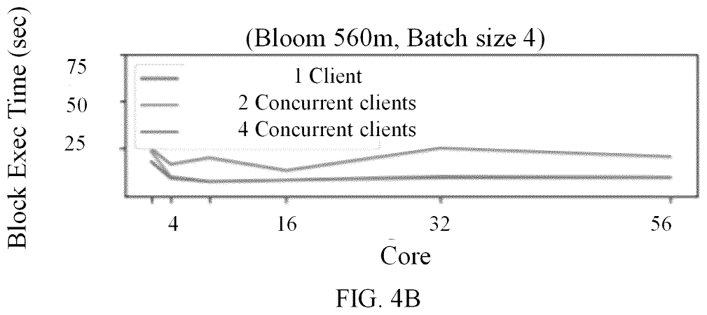

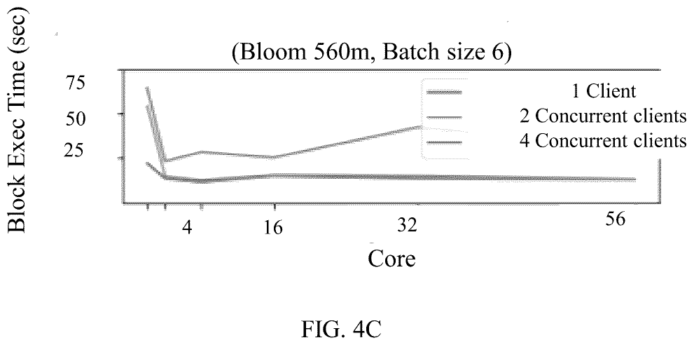

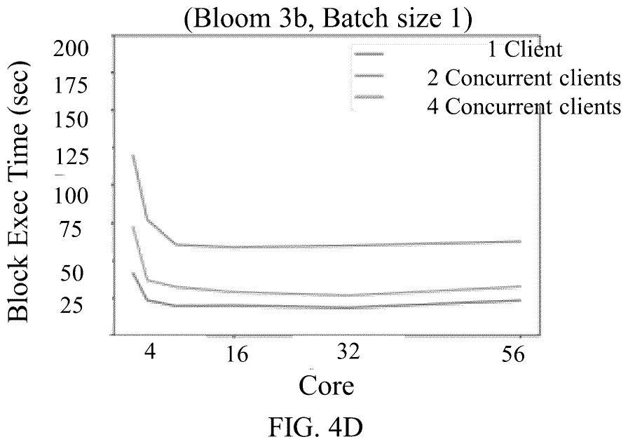

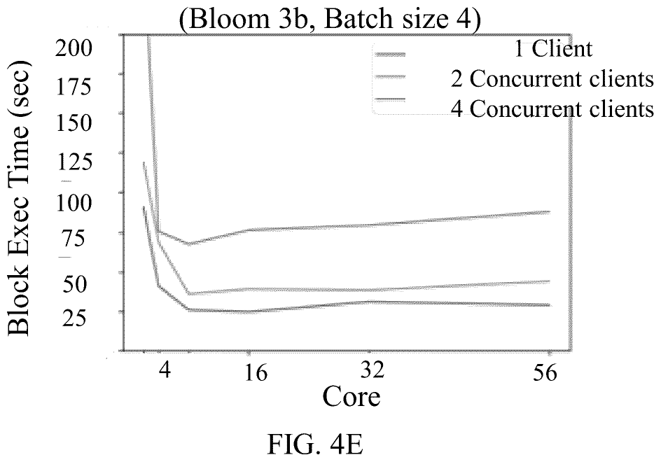

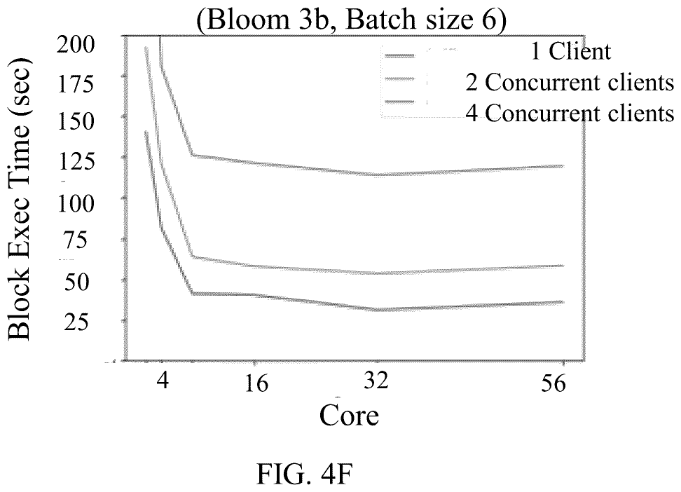

Although the data repository 110 is shown internal to the system 100, it will be noted that, in alternate embodiments, the data repository 110 can also be implemented external to the system 100, where the data repository 110 may be stored within a database (repository 110) communicatively coupled to the system 100. The data contained within such external database may be periodically updated. For example, new data may be added into the database (not shown in FIG. 1) and/or existing data may be modified and/or non-useful data may be deleted from the database. In one example, the data may be stored in an external system, such as a Lightweight Directory Access Protocol (LDAP) directory and a Relational Database Management System (RDBMS). Functions of the components of the system 100 are now explained with reference to the functional block diagram in FIG. 2, steps in flow diagrams in FIG. 3, and the graphs in FIG. 4.

FIG. 2 is a functional block diagram of the system of FIG. 1, according to some embodiments of the present disclosure. As depicted, transformer model size and number of transformer model blocks are given as input to the system 100. The system 100 uses method 300 as in FIG. 3, to determine priorities of worker nodes, and in turn the transformer model blocks are allocated among the plurality of worker nodes. This is further explained in the method 300 description with reference to FIG. 3.

FIG. 3 is a flow diagram depicting steps involved in the process of the optimal placement of blocks across worker nodes in the distributed computing environment, using the system of FIG. 1, in accordance with some embodiments of the present disclosure.

In an embodiment, the system 100 comprises one or more data storage devices or the memory 104 operatively coupled to the processor(s) 102 and is configured to store instructions for execution of steps of the method 300 by the processor(s) or one or more hardware processors 102. The steps of the method 300 of the present disclosure will now be explained with reference to the components or blocks of the system 100 as depicted in FIG. 1 and the steps of flow diagram as depicted in FIG. 3. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

In machine learning context, a transformer model is a multi-thread attention-based deep learning architecture that is used for training of machine learning models. The transformer model contains a plurality of transformer blocks (alternately referred to as ‘transformer model blocks’). In a distributed framework, the transformer blocks can be distributed across different servers (alternately referred to as ‘worker nodes’) in the network, using steps in the method 300 in FIG. 3, as explained below.

At step 302 of the method 300, the system 100 collects an input data comprising a) size of a plurality of the transformer model blocks to be distributed across a plurality of the worker nodes, b) information on the plurality of worker nodes available for servicing data in the plurality of transformer blocks, c) available memory with each of the plurality of worker nodes, d) available cores with each of the plurality of worker nodes, e) number of blocks on each of the plurality of worker nodes, and f) a current overhead on each of the plurality of worker nodes. The size of the plurality of the transformer model blocks indicates overall size of the transformer model that is to be distributed across the plurality of worker nodes.

Further, at step 304 of the method 300, the system 100 determines a left-over memory capacity of each of the plurality of worker nodes. The system 100 may determine the left-over memory capacity of each of the plurality of transformer model blocks based on the available memory the available cores with each of the plurality of worker nodes, considering current overhead of each of the worker nodes. The available memory indicates memory space that is unallocated or unutilized, and the available core data indicates number of cores that are unallocated or unutilized, thus making them available for handling one or more of the plurality of the transformer model blocks.

Further, at step 306 of the method 300, the system 100 determines a preference score for the memory and cores in each of the plurality of worker nodes. In an embodiment, the system 100 may determine the preference score based on one or more preferences set by an authorized user. For example, certain applications may require more memory than cores, whereas some other applications may require more core than memory. Depending on the requirements, the preferences maybe set, and accordingly the system 100 determines the preference score.

Further, at step 308 of the method 300, the system 100 generates a consistent comparison matrix comprising normalized values of the preference score of the memory and cores in each of the plurality of worker nodes. In an embodiment, the system 100 generates the consistent comparison matrix by normalizing the preference scores of the memory and cores. The consistent comparison matrix maybe of pre-defined size (for example, 2*2, 3*3 etc.), and contain the normalized values of the preference scores. As the values in the consistent comparison matrix are all normalized values, the matrix is also called normalized consistent comparison matrix.

Further, at step 310 of the method 300, the system 100 determines a weighted average of the memory and cores in each of the plurality of worker nodes, using data in the consistent comparison matrix.

Further, at step 312 of the method 300, the system 100 determines a final weighted average score for each of the plurality of worker nodes, as:

W[Scoresᵢ]←(Wₘ*LM(Sᵢ))+(W_{c}_{ᵢ}*AC(Sᵢ)), wherein,
W[Scores_{I}] is the final weighted average score, Wₘ is a weighted memory score, LM(Sᵢ) is the left-over memory capacity, W_{c}_{ᵢ} is a weighted core score, and AC(Sᵢ) is the number of available cores, for i^{th} worker node of the plurality of worker nodes.

The final weighted average score represents availability of each of the plurality of worker nodes for processing the data to be processed. Further, at step 314 of the method 300, the system 100 allocates the plurality of transformer model blocks to one or more of the plurality of worker nodes, by prioritizing each of the plurality of worker nodes based on the final weighted average score, resulting in optimal placement of the model blocks across the plurality of worker nodes. At this step, the system 100 may sort the plurality of worker nodes in descending order of the final weighted average score. Then the system 100 determines number of blocks to be assigned to each of the worker nodes, based on a) the left-over memory capacity of each of the plurality of worker nodes, and b) size of each of the blocks of the data to be processed, i.e., by dividing the left over memory at each worker node by the size of each of the transformer blocks.

An algorithmic representation of the method 300 is given as:

```
    Require:
  • TBₛ - Size of transformer model block
  • Pₒ - Current Overhead
  • S - Cluster of enterprise workers
  • AM_{S} - Available memory for each worker node
  • AC_{S} - Available cores for each worker node
  • Nb(S) - Number of blocks on a worker node
  Ensure: Optimal block placement on servers
    1: for each worker node in cluster Sᵢ ⊆ S do
    2: LM(Sᵢ) ← (AM(Sᵢ) − Pₒ )
    3: AC(Sᵢ) ← Available cores of worker node
    4: end for
    5: for each worker node in the cluster Sᵢ ⊆ S do
    6: Assign preference scores for memory and cores
    7: M(Scoresᵢ) ← Normalized matrix of scores
    8: Wₘ_{ᵢ} ← weighted memory score using M[Scoresᵢ]
    9: W_{c}_{ᵢ} ← weighted core score using M[Scoresᵢ]
  10: [W_{Score}_{ᵢ}] ← (Wₘ * LM(Sᵢ)) + (W_{c}_{ᵢ} * AC (Sᵢ))
  11: end for
  12: S[W_{Score}_{ᵢ}]_{sorted} ← List of sorted servers based on scores
  13: Assign blocks to each server from S[W_{Score}_{ᵢ}]_{sorted} list s.t.
Nb(Sᵢ) ← LM(Sᵢ)/TBₛ
  14: Allocate blocks on each server for inference
```

### Experiment Setup

a. AI models used:

The experiments were conducted with 3 different open-source LLMs, namely BLOOM, LLAMA, and Falcon. BLOOM is a multi-lingual large language model that has the ability to generate text in 46 natural languages and 13 programming languages. BLOOM model comes in multiple variants. The experiments were conducted on 3 variants-namely 560 million, 3 billion and 7 billion parameter versions of BLOOM. The multiple variants enabled deep evaluation of efficacy of the method 300. Another model that was used for evaluation was LLaMA (Large Language Model Meta AI), which is a family of LLMs released by Meta AI. LLAMA has multiple variants and the experiments are conducted on the 70 billion version of the LLAMA model. Additionally, the experiments were conducted on Falcon which a generative large language model. Falcon comes in multiple variants and LLaMPS was evaluated on the billion version of Falcon.

b. Heterogeneous Enterprise Cluster

The experimental set-up was used to utilize left-over capacities of servers utilized by members of the labs. 5 CPU-based servers and the configuration of these servers were used, as depicted in Table 2. All servers have heterogeneous configuration in terms of operation system, OS version, cores and memory, which is a typical real world set-up in any enterprise. The left-over capacity was leveraged to optimally distribute blocks of large language models such that the number of users can be maximized. Table 2 provides details of the different servers and also distinguishes between the “Client” and four different servers (“Server 1,” “Server 2,”, “Server 3” and “Server 4”) and their respective configurations.

The system 100 utilizes its services for various tasks, including the creation and initialization of the Distributed Hash Table (DHT) and the loading of transformer blocks. The overhead and impact of these factors on performance of the method 300 within were analyzed through a systematic analysis. In this experiment, PETALS, which is an existing approach using resource sharing concept, served as an open-source foundation for the system 100, supporting block distribution and other DHT-related operations.

To predict the memory overhead linked to PETALS, an equation was formulated with two variables: the number of blocks and number of model parameters, and resulting predictive model was proven to be valuable for the block placement purpose.

Table 1 displays the outcomes of four regression models-Linear Regression, LGBM Regression, Polynomial Regression, and Decision Tree Regression—applied to 150 data points. The experiments revealed that the Decision Tree Regression model outperforms the other three, demonstrating an R-squared value of 0.998 and an MSE of 19.75. Consequently, the Decision Tree Regression model was employed for predicting Petals' Memory Overhead.

Three factors within the distributed framework contributed to the overall overhead: the memory required for allocated packages (10 GB), the overhead determined by the Decision Tree Regressor model, and the Attention cache's size. The size of the attention cache was calculated as twice the model's hidden size multiplied by 4096 times the tensor size (4 bytes for CPU). Together, these factors collectively constituted the Petals Framework Overhead, quantified as:

$$Petals Memory Overhead + Attention Cache size + 10 GB \qquad ( 1 )$$

The system 100 used this formula to calculate Petals Framework Overhead for block placement during the experiments.

### C. Experiments Conducted:

Various experiments were performed on approaches in a Greedy algorithm and method 300 by varying the model parameters, servers, clients, cores, batch size, and token length.

TABLE 2
Server Configuration Information

| | OS | | | |
|---|---|---|---|---|
| Server | Version | Kernel | Memory(GB) | Cores |
| Client | Ubuntu | 5.4.0 | 62.8 | 48 |
| | 18.04.6 | | | |
| Server | Ubuntu | 5.4.0 | 252 | 56 |
| 1 | 18.04.6 | | | |
| Server | Ubuntu | 5.19.0 | 992 | 88 |
| 2 | 22.04.3 | | | |
| Server | CentOS | 3.10.0 | 504 | 56 |
| 3 | 7 | | | |
| Server | CentOS | 3.10.0 | 256 | 56 |
| 4 | 7.8 | | | |

Given below the details of various parameters used in experiments.
Model): The experiments were conducted using the “bloom560m,” “bloom-3b,” “bloom-7b1,” “falcon-40b,” and “llama-70b” models.
Block Distribution: The “Block_distribution” varied between “[24]” for “bloom-560m” and “[30]” for “bloom-3b” and “bloom-7b1.” In the “falcon-40b” and “llama-70b” models, the block distribution was specified as “(32,28)” and “(35,25,20)” respectively.
Memory: The “Memory” column indicates the memory configurations used for each experiment. For example, “[12, 14, 14, 14]” in “bloom-560m” refers to the memory allocated on a single server.
Cores: The “Cores” column specifies the number of cores allocated to each server. It varied for different models and experiments.
Selected Servers: This column lists the selected servers for each experiment. It may include server configurations and the number of servers, like “[14,2]” or “(35,25,20)”.
Clients: C1, C2 and C4 represent number of clients being 1, 2, and 4.
Block Execution Time C1, C2, C4: The “Block Execution Time” columns represent the execution time for different clients (C1, C2, C4) under both the “Greedy” and “method 300” approaches.
Batch Size: Batch size refers to the quantity of input data grouped together. In the context of text generation with a transformer model, a batch size of 1 corresponds to generating text based on a single input sentence. Conversely, a batch size of ‘n’ involves generating text for ‘n’ input sentences concurrently, sending all ‘n’ sentences to the transformer simultaneously.
Token: The “number of tokens” refers to the quantity of output tokens produced by a transformer model. For instance, in text generation using a transformer model, having 100 tokens means generating a sequence of 100 words.
   d. Varying the Cores->Pick Best the Core

Assigning servers (worker nodes) based on a combination of memory and cores is a basic premise of method 300. In the experiments across various versions of the Bloom model (FIG. 4), a notable observation emerged: the optimal performance was achieved at 8 cores, i.e., additional cores beyond 8 did not give any significant performance improvement. To validate the observations, experiments were systematically conducted with varying configurations, namely 2, 4, 8, 16, 32, and 56 cores. As shown in FIG. 4, beyond the 8-core threshold, the block execution stabilized, revealing a clear knee point in the performance curve. The results were consistent across multiple flavors of the BLOOM model and also support multiple concurrent clients.

e. Model Fits on a Single Server

Table 3 depicts experiments conducted for varying flavors of BLOOM, LLAMA and the Falcon models. The method 300 was compared with the greedy-memory approach for the choice of servers selected for block distribution. Block execution time in each case for a single and concurrent clients. Experiments were conducted with the method 300 on a single server, adjusting client loads across 1, 2, and 4 concurrent clients. These trials were conducted on three distinct models. Notably, ‘1 server’ reference implies that all transformer blocks are positioned on a single server, while ‘1 client’ signifies a lone user sending input queries to the server. Conversely, ‘2 concurrent clients’ and ‘4 concurrent clients’ denote two and four concurrent users sending input queries to the server. The servers are named as S1, S2, S3 and S4. There server tuple is represented as S (available memory in GBs, Available cores). Aim of these experiments was to ensure optimal distribution of transformer blocks such that the number of clients served is maximized.

For the Bloom-560m model, four servers—S1, S2, S3, and S4 with heterogeneous memory and core specifications were utilized. The Greedy Approach was opted for S2 to distribute all 24 blocks, whereas the method 300 selected server S4. Comparing block execution times using a batch size of 16 and token size of 10, inference using GMA took 3.09 seconds for 1 client, 4.87 seconds for 2 concurrent clients, and 9.73 seconds for 4 concurrent clients. Conversely, inference using the method 300 resulted in execution times of 2.02 seconds for 1 client, 3.01 seconds for 2 concurrent clients, and 4.56 seconds for 4 concurrent clients. Notably, the block execution times for METHOD 300 with 1, 2, and 4 concurrent clients were lower than the Greedy Approach with a single client. Therefore, the method 300 exhibited better performance for 1 and 2 concurrent clients compared to the Greedy Approach for 1 client, while the method 300 across 1, 2, and 4 concurrent clients outperformed the Greedy Approach with 2 concurrent clients.

For the Bloom-3b model, similar to the Bloom-560m model, four servers (S1, S2, S3, and S4) were utilized, each with distinct memory and core configurations. The Greedy Approach selected S2 to distribute all 30 blocks, whereas method 300 utilized the S4 server. The block execution times using the Greedy Approach were 17.01 seconds for 1 client, 28.43 seconds for 2 concurrent clients, and 59.46 seconds for 4 concurrent clients. However, with method 300, the execution times were notably lower: 7.12 seconds for 1 client, 10.12 seconds for 2 concurrent clients, and 20.15 seconds for 4 concurrent clients. Once again, method 300 exhibited better performance for 1 and 2 concurrent clients compared to the Greedy Approach for 1 client, while outperforming the Greedy Approach across 1, 2, and 4 concurrent clients.

For the Bloom-7b model, with the same set of servers (S1, S2, S3, and S4) and their corresponding memory and core specifications, the Greedy Approach opted for S2 to distribute all 30 blocks, whereas method 300 selected the use of the S4 server. The block execution times using the Greedy Approach were 45.02 seconds for 1 client, 83.21 seconds for 2 concurrent clients, and 179.01 seconds for 4 concurrent clients. However, employing method 300 resulted in significantly lower execution times: 20.1 seconds for 1 client, 34.5 seconds for 2 concurrent clients, and 67.44 seconds for 4 concurrent clients. Similar to the previous models, method 300 demonstrated superior performance for 1 and 2 concurrent clients compared to the Greedy Approach for 1 client, and across 1, 2, and 4 concurrent clients compared to the Greedy Approach with 2 concurrent clients.

Next set of experiments focused on scenarios where the left-over capacity of servers is insufficient even to load the smallest version of the BLOOM model.

f. Models Fits on 2 Servers

As in Table 3, experiments were conducted with distribution across two servers, varying client loads with 1, 2, and 4 concurrent clients. These trials encompassed two different models, including three versions of the Bloom model, the Falcon model.

When a single server couldn't accommodate all transformer blocks, two servers were used. Additionally, with a batch size of 16 and a fixed token length of 10, the method 300 indicated an increase in block execution time as the number of concurrent clients increased, specifically with 2 concurrent clients.

Blocks of the Bloom 560m model was allocated using both the Greedy and method 300 across servers S1, S2, S3, and S4. S1 has 13.5 GB memory with 8 cores, S2 has 12 GB memory with 2 cores, while S3 and S4 possess 12 GB memory with 4 and 8 cores, respectively. The Greedy Approach picked S1 (14 blocks) and S2 (10 blocks), while the method 300 selected S1 and S4. Block execution times with the Greedy Approach were 3.73 seconds for 1 client, 4.49 seconds for 2 concurrent clients, and 8.82 seconds for 4 concurrent clients. In contrast, the method 300 resulted in notably lower execution times: 2.75 seconds for 1 client, 2.88 seconds for 2 concurrent clients, and 3.11 seconds for 4 concurrent clients. The method 300 demonstrated superior performance for 1 and 2 concurrent clients compared to the Greedy Approach for 1 client, and across 1, 2, and 4 concurrent clients compared to the Greedy Approach with 1 client.

TABLE 3
Method 300 vs Greedy on 1, 2, 3 servers
Bloom 560m - (batch size = 16, tokens = 10)
Servers: (GB, cores) [S1(12, 2), S2(14, 2), S3(14, 4), S4(14, 8)]

| | batch | token | Selected | Block | 1 | 2 | 4 |
|---|---|---|---|---|---|---|---|
| Approach | size | length | Servers | Distrbn | client | clients | clients |
| GMA | 16 | 10 | (S2) | [24] | 3.89 | 4.87 | 9.73 |
| METHOD | 16 | 10 | (S4) | [24] | 2.02 | 3.01 | 4.56 |
| 300 | | | | | | | |

Servers: (GB, cores) [S1(13.5, 8),
S2(12, 2), S3(12, 4), S4(12, 8)]

| | | | | | | | |
|---|---|---|---|---|---|---|---|
| GMA | 16 | 10 | (S1, S2) | [14, 10] | 3.73 | 4.49 | 8.82 |
| METHOD | 16 | 10 | (S1, S4) | [14, 10] | 2.43 | 2.59 | 3.65 |
| 300 | | | | | | | |

Servers: (GB, cores) [S1(12.15, 8), S2(11.65, 8),
S3(11.15, 2), S4(11.15, 4), S5(11.15, 2)]

| | | | | | | | |
|---|---|---|---|---|---|---|---|
| GMA | 16 | 10 | (S1, S2, S3) | [12, 8, 4] | 2.75 | 3.01 | 3.65 |
| METHOD | 16 | 10 | (S1, S2, S5) | [12, 8, 4] | 2.68 | 2.88 | 3.11 |
| 300 | | | | | | | |

Bloom 3b - (batch size = 16, tokens = 10)
Servers: (GB, cores) [S1(23, 8), S2(23.5, 2), S3(23.5, 4), S4(23.5, 8)]

| | batch | token | Selected | Block | 1 | 2 | 4 |
|---|---|---|---|---|---|---|---|
| Approach | size | length | Servers | Distrbn | client | clients | clients |
| GMA | 16 | 10 | (S2) | [30] | 17.01 | 28.43 | 59.46 |
| METHOD | 16 | 10 | (S4) | [30] | 7.12 | 10.12 | 20.15 |
| 300 | | | | | | | |

Servers: (GB, cores) [S1(17.5, 8),
S2(16.7, 2), S3(16.7, 4), S4(16.7, 8)]

| | | | | | | | |
|---|---|---|---|---|---|---|---|
| GMA | 16 | 10 | (S1, S2) | [16, 14] | 18.11 | 28.62 | 54.44 |
| METHOD | 16 | 10 | (S1, S4) | [16, 14] | 8.6 | 9.97 | 19.13 |
| 300 | | | | | | | |

Servers: (GB, cores) [S1(16.7, 8), S2(15, 2),
S3(13.3, 2), S4(13.3, 4), S5(13.3, 8)]

| | | | | | | | |
|---|---|---|---|---|---|---|---|
| GMA | 16 | 10 | (S1, S2, S3) | [14, 10, 6] | 10.93 | 12.09 | 14.11 |
| METHOD | 16 | 10 | (S1, S2, S5) | [14, 10, 6] | 10.28 | 11.23 | 13.91 |
| 300 | | | | | | | |

Bloom 7b1 - (batch size = 16, tokens = 10)
Servers: (GB, cores) [S1(42, 8), S2(44, 2), S3(44, 4), S4(44, 8)]

| | batch | token | Selected | Block | 1 | 2 | 4 |
|---|---|---|---|---|---|---|---|
| Approach | size | length | Servers | Distrbn | client | clients | clients |
| GMA | 16 | 10 | (S2) | [30] | 45.02 | 83.21 | 179.01 |
| METHOD | 16 | 10 | (S4) | [30] | 20.1 | 34.5 | 67.44 |
| 300 | | | | | | | |

Servers: (GB, cores) [S1(31, 8),
S2(30, 2), S3(30, 4), S4(30, 8)

| | | | | | | | |
|---|---|---|---|---|---|---|---|
| GMA | 16 | 10 | (S1, S2) | [16, 14] | 46.78 | 70.12 | 160.12 |
| METHOD | 16 | 10 | (S1, S4) | [16, 14] | 23.08 | 24.98 | 42.01 |
| 300 | | | | | | | |

Servers: (GB, cores) [S1(30, 8), S2(26, 8),
S3(22, 2), S4(22, 4), S5(22, 8)]

| | | | | | | | |
|---|---|---|---|---|---|---|---|
| GMA | 16 | 10 | (S1, S2, S3) | [14, 10, 6] | 27.79 | 29.12 | 38.35 |
| METHOD | 16 | 10 | (S1, S2, S5) | [14, 10, 6] | 22.12 | 23.59 | 36.12 |
| 300 | | | | | | | |

Falcon-40b - (batch size = 16, tokens = 10)
Servers: (GB, cores) [S1(98.3, 8), S2(88, 2), S3(88, 4), S4(88, 8)]

| | batch | token | Selected | Block | 1 | 2 | 4 |
|---|---|---|---|---|---|---|---|
| Approach | size | length | Servers | Distrbn | client | clients | clients |
| GMA | 16 | 10 | (S1, S2) | [32, 28] | 491.2 | 536.12 | 840.02 |
| METHOD | 16 | 10 | (S1, S4) | [32, 28] | 211.37 | 305.12 | 682.01 |
| 300 | | | | | | | |

Servers: (GB, cores) [S1(93.2, 2), S2(67.5, 8),
S3(42, 2), S4(42, 4), S5(42, 8)]

| | | | | | | | |
|---|---|---|---|---|---|---|---|
| GMA | 16 | 10 | (S1, S2, S3) | [30, 20, 10] | 260.12 | 266.72 | 352.12 |
| METHOD | 16 | 10 | (S1, S2, S5) | [30, 20, 10] | 258.19 | 263.89 | 345.26 |
| 300 | | | | | | | |

Llama2-70b - (batch size = 16, tokens = 10)
Servers: (GB, cores) [S1(155, 8), S2(113.5, 2), S3(83.5, 2), S4(83.5, 4), S5(83.5, 8)]

| | batch | token | Selected | Block | 1 | 2 | 4 |
|---|---|---|---|---|---|---|---|
| Approach | size | length | Servers | Distrbn | client | clients | clients |
| GMA | 16 | 10 | (S1, S2, S3) | [35, 25, 20] | 396.11 | 408.12 | 798.12 |
| METHOD | 16 | 10 | (S1, S2, S5) | [35, 25, 20] | 279.13 | 304.11 | 588.76 |
| 300 | | | | | | | |

For the Bloom 3b model, the blocks were distributed using both Greedy and method 300 across servers S1, S2, S3, and S4. S1 offers 17.5 GB memory with 8 cores, S2 has 16 GB memory with 2 cores, while S3 and S4 possess 16 GB memory with 4 and 8 cores, respectively. The Greedy Approach selected S1 (16 blocks) and S2 (14 blocks), while method 300 chose S1 and S4. Block execution times with the Greedy Approach were 18.11 seconds for 1 client, 28.63 seconds for 2 concurrent clients, and 54.44 seconds for 4 concurrent clients. However, method 300 resulted in significantly lower execution times: 8.6 seconds for 1 client, 9.97 seconds for 2 concurrent clients, and 19.13 seconds for 4 concurrent clients. Similar to previous models, method 300 exhibited superior performance for 1 and 2 concurrent clients compared to the Greedy Approach for 1 client, and across 1, 2, and 4 concurrent clients compared to the Greedy Approach with 2 concurrent clients.

In the case of the Bloom 7b1 model, both Greedy and method 300 methods to distribute its blocks across servers S1, S2, S3, and S4. S1 has 31 GB memory with 8 cores, S2 has 30 GB memory with 2 cores, while S3 and S4 have 30 GB memory with 4 and 8 cores, respectively. The Greedy Approach opted for S1 (16 blocks) and S2 (14 blocks), whereas method 300 chose S1 and S4. Block execution times with the Greedy Approach were 46.78 seconds for 1 client, 70.12 seconds for 2 concurrent clients, and 160.12 seconds for 4 concurrent clients. However, method 300 resulted in notably lower execution times: 23.1 seconds for 1 client, 24.98 seconds for 2 concurrent clients, and 42.01 seconds for 4 concurrent clients. As with previous models, method 300 showcased better performance for 1 and 2 concurrent clients compared to the Greedy Approach for 1 client, and across 1, 2, and 4 concurrent clients compared to the Greedy Approach with 1 client.

For the Falcon model, both Greedy approach and method 300 were employed to distribute all 60 blocks across servers S1, S2, S3, and S4. S1 offers 98.3 GB memory with 8 cores, S2 has 88.2 GB memory with 2 cores, while S3 and S4 possess 88.2 GB memory with 4 and 8 cores, respectively. The Greedy Approach selected S1 (14 blocks) and S2 (10 blocks), whereas method 300 chose S1 and S4. Notably, for Client 1, Greedy exhibited a block execution time of 491.2 seconds, while method 300 showed 211.37 seconds for Client 1 and 305.5 seconds for Client 2, signifying an improvement over Client 1 using Greedy. This observed trend remained consistent across other models as well.

g. Model Fits on 3 Servers

Further experiments were conducted with method 300 block placement approach across three servers, varying the client loads between 1, 2, and 4 concurrent clients. These trials encompassed three different models, including three versions of the Bloom model, the Falcon model, and the LLaMA 2 model. When left-over capacity of a single or two servers was insufficient to accommodate all transformer blocks the experiment was designed using 3 servers. Notably, when employing the method 300 algorithm with 2 concurrent clients, the block execution time increased with a higher number of concurrent clients, all the while maintaining a batch size of 16 and a fixed token length of 10.

In the context of the Falcon model presented in Table 3, the blocks were distributed using both Greedy and method 300 methods across servers S1, S2, S3, S4, and S5. These servers possess varying memory and core configurations, with Greedy selecting S1, S2, and S3, while method 300 opted for S1, S2, and S5. Specifically, for Client 1 in Greedy, the block execution time recorded was 260.12 seconds. However, utilizing method 300, the block execution time was 258.19 seconds for Client 1 and 263.89 seconds for Client 2, demonstrating comparable performance to that of Client 1 in Greedy.

Bloom 560m: Utilizing both Greedy and method 300 techniques, all 24 blocks were allocated among servers S1, S2, S3, S4, and S5. S1 had 12.15 GB memory and 8 cores, S2 holds 11.65 GB memory with 8 cores, while S3, S4, and S5 share 11.15 GB memory but differ in core count-2, 4, and 8 cores respectively. The Greedy method selected S1, S2, and S3, whereas method 300 favored S1 (12 blocks), S2 (8 blocks), and S5 (4 blocks). Under the Greedy approach, block execution times for 1 client were 2.75 seconds, 2 concurrent clients took 3.01 seconds, and 4 concurrent clients demanded 3.65 seconds. Meanwhile, employing method 300 resulted in execution times of 2.68 seconds for 1 client, 2.88 seconds for 2 concurrent clients, and 3.11 seconds for 4 concurrent clients. The method 300 showcased superior performance across 1, 2, and 4 concurrent clients in contrast to the Greedy Approach.

Bloom 3b: All 30 blocks were allocated across servers S1, S2, S3, S4, and S5 using both Greedy and method 300 methodologies. S1 possesses 16.7 GB memory and 8 cores, S2 holds 15 GB memory with 8 cores, while S3, S4, and S5 share 13.3 GB memory, differing in core count-2, 4, and 8 cores respectively. Greedy method favored S1, S2, and S3, while method 300 distributed 14 blocks to S1, 10 blocks to S2, and 6 blocks to S5. Block execution times under Greedy for 1 client were 10.93 seconds, 12.09 seconds for 2 concurrent clients, and 14.11 seconds for 4 concurrent clients. With method 300, execution times were 10.28 seconds for 1 client, 11.23 seconds for 2 concurrent clients, and 13.91 seconds for 4 concurrent clients. method 300 demonstrated superior performance across 1, 2, and 4 concurrent clients compared to the Greedy Approach.

Bloom 7b1: Distributing all 30 blocks across servers S1, S2, S3, S4, and S5 was achieved using Greedy and method 300 methods. S1 boasts GB memory and 8 cores, S2 holds 26 GB memory with 8 cores, while S3, S4, and S5 share 22 GB memory but differ in core count-2, 4, and 8 cores respectively. Greedy method selected S1, S2, and S3, whereas method 300 allocated 14 blocks to S1, 10 blocks to S2, and 6 blocks to S5. Under Greedy, block execution times were 27.79 seconds for 1 client, 29.12 seconds for 2 concurrent clients, and 38.35 seconds for 4 concurrent clients. Meanwhile, method 300 showed execution times of 22.12 seconds for 1 client, 23.59 seconds for 2 concurrent clients, and 36.12 seconds for 4 concurrent clients. method 300 showcased superior performance across 1, 2, and 4 concurrent clients compared to the Greedy Approach. (4) Falcon model: All 60 blocks were distributed across servers S1, S2, S3, S4, and S5 using Greedy and method 300 methodologies. S1 possesses 92.2 GB memory and 8 cores, S2 has 67.7 GB memory with 8 cores, while S3, S4, and S5 share 42 GB memory, differing in core count-2, 4, and 8 cores respectively. Greedy method selected S1, S2, and S3, whereas method 300 opted for S1, S2, and S5. Under Greedy, block execution times were 260.12 seconds for 1 client, 266.72 seconds for 2 concurrent clients, and 352.12 seconds for 4 concurrent clients. Method 300 demonstrated execution times of 258.19 seconds for 1 client, 263.89 seconds for 2 concurrent clients, and 345.26 seconds for 4 concurrent clients. Method 300 showcased superior performance across 1, 2, and 4 concurrent clients compared to the Greedy Approach.

LLama 2 model: Employing both Greedy and method 300 methods, all 80 blocks were distributed among servers S1, S2, S3, S4, and S5. S1 boasts 155 GB memory and 8 cores, S2 holds 113.5 GB memory with 8 cores, while S3, S4, and S5 share 83.5 GB memory, differing in core count-2, 4, and 8 cores respectively. Greedy method selected S1, S2, and S3, while method 300 favored S1 (35 blocks), S2 (25 blocks), and S5 (20 blocks). Block execution times under Greedy for 1 client were 396.11 seconds, 408.12 seconds for 2 concurrent clients, and 798.12 seconds for 4 concurrent clients. Meanwhile, employing method 300 resulted in execution times of 279.13 seconds for 1 client, 404.11 seconds for 2 concurrent clients, and 588.76 seconds for 4 concurrent clients. Method 300 demonstrated superior performance across 1, 2, and 4 concurrent clients compared to the Greedy Approach.

As observed from the results in Table 3, the method 300 outperforms GMA in almost all the cases, with a lower block execution time as compared to GMA. These results are consistent across different models. BLOOM, Falcon and LLAMA 2 with varying parameters and number of clients.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address unresolved problem of optimal placement of blocks on worker nodes in a distributed computing environment. The embodiment, thus provides a mechanism for prioritizing worker nodes based on left over memory. Moreover, the embodiments herein further provide mechanism for distributing blocks of a transformer model across the worker nodes, based on the determined priority and size of the blocks.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, comprising:
collecting, via one or more hardware processors, an input data comprising a) size of a plurality of transformer model blocks to be distributed across a plurality of worker nodes, b) information on the plurality of worker nodes available for servicing data in the plurality of transformer blocks, c) available memory with each of the plurality of worker nodes, d) available cores with each of the plurality of worker nodes, e) number of blocks on each of the plurality of worker nodes, and f) a current overhead on each of the plurality of worker nodes;
determining, via the one or more hardware processors, a left-over memory capacity of each of the plurality of worker nodes;
determining, via the one or more hardware processors, a preference score for the memory and cores in each of the plurality of worker nodes;
generating, via the one or more hardware processors, a consistent comparison matrix comprising normalized values of the preference score of the memory and cores in each of the plurality of worker nodes;
determining, via the one or more hardware processors, a weighted average of the memory and cores in each of the plurality of worker nodes, using data in the consistent comparison matrix;
determining, via the one or more hardware processors, a final weighted average score for each of the plurality of worker nodes, wherein the final weighted average score represents availability of each of the plurality of worker nodes for processing the data to be processed; and
allocating the plurality of transformer model blocks, via the one or more hardware processors, to one or more of the plurality of worker nodes, by prioritizing each of the plurality of worker nodes based on the final weighted average score.

2. The method of claim 1, wherein the left-over memory capacity is determined based on the available memory and the current overhead.

3. The method of claim 1, wherein the final weighted average score of each of the plurality of worker nodes is determined as:
[W_{score}_{ᵢ}]←(Wₘ*LM(Sᵢ)+(W_{c}_{ᵢ}*AC(Sᵢ)), wherein,
W_{scorei} is the final weighted average score, Wₘ is a weighted memory score, LM(Sᵢ) is the left-over memory capacity, W_{ci} is a weighted core score, and AC(Sᵢ) is the number of available cores, for i^{th} worker node of the plurality of worker nodes.

4. The method of claim 1, wherein allocating the plurality of transformer model blocks, to one or more of the plurality of worker nodes comprises of:
determining number of blocks in the transformer model, to be loaded to each of the plurality of worker nodes, based on a) the left-over memory capacity of each of the plurality of worker nodes, and b) size of each of the blocks of the data to be processed; and
loading the determined number of blocks to each of the plurality of worker nodes.

5. A system, comprising:
one or more hardware processors;
a communication interface; and
a memory storing a plurality of instructions, wherein the plurality of instructions cause the one or more hardware processors to:
collect an input data comprising a) size of a plurality of transformer model blocks to be distributed across a plurality of worker nodes, b) information on the plurality of worker nodes available for servicing data in the plurality of transformer blocks, c) available memory with each of the plurality of worker nodes, d) available cores with each of the plurality of worker nodes, e) number of blocks on each of the plurality of worker nodes, and f) a current overhead on each of the plurality of worker nodes;
determine a left-over memory capacity of each of the plurality of worker nodes;
determine a preference score for the memory and cores in each of the plurality of worker nodes;
generate a consistent comparison matrix comprising normalized values of the preference score of the memory and cores in each of the plurality of worker nodes;
determine a weighted average of the memory and cores in each of the plurality of worker nodes, using data in the consistent comparison matrix;
determine a final weighted average score for each of the plurality of worker nodes, wherein the final weighted average score represents availability of each of the plurality of worker nodes for processing the data to be processed; and
allocate the data to be processed to one or more of the plurality of worker nodes, by prioritizing each of the plurality of worker nodes based on the final weighted average score.

6. The system of claim 5, wherein the one or more hardware processors are configured to determine the left-over memory capacity is determined based on the available memory and the current overhead.

7. The system of claim 5, wherein the one or more hardware processors are configured to determine the final weighted average score of each of the plurality of worker nodes as:
[W_{score}_{ᵢ}]←(Wₘ*LM(Sᵢ)+(W_{c}_{ᵢ}*AC(Sᵢ)), wherein,
W_{Scorei} is the final weighted average score, Wₘ is a weighted memory score, LM(Sᵢ) is the left-over memory capacity, W_{ci} is a weighted core score, and AC(Sᵢ) is the number of available cores, for i^{th} worker node of the plurality of worker nodes.

8. The system of claim 5, wherein the one or more hardware processors are configured to allocate the plurality of transformer model blocks, to one or more of the plurality of worker nodes, by:
determining number of blocks in the transformer model, to be loaded to each of the plurality of worker nodes, based on a) the left-over memory capacity of each of the plurality of worker nodes, and b) size of each of the blocks of the data to be processed; and
loading the determined number of blocks to each of the plurality of worker nodes.

9. One or more non-transitory machine-readable information storage mediums comprising one or more instructions which when executed by one or more hardware processors cause:
collecting an input data comprising a) size of a plurality of transformer model blocks to be distributed across a plurality of worker nodes, b) information on the plurality of worker nodes available for servicing data in the plurality of transformer blocks, c) available memory with each of the plurality of worker nodes, d) available cores with each of the plurality of worker nodes, e) number of blocks on each of the plurality of worker nodes, and f) a current overhead on each of the plurality of worker nodes;
determining a left-over memory capacity of each of the plurality of worker nodes;
determining a preference score for the memory and cores in each of the plurality of worker nodes;
generating a consistent comparison matrix comprising normalized values of the preference score of the memory and cores in each of the plurality of worker nodes;
determining a weighted average of the memory and cores in each of the plurality of worker nodes, using data in the consistent comparison matrix;
determining a final weighted average score for each of the plurality of worker nodes, wherein the final weighted average score represents availability of each of the plurality of worker nodes for processing the data to be processed; and
allocating the plurality of transformer model blocks to one or more of the plurality of worker nodes, by prioritizing each of the plurality of worker nodes based on the final weighted average score.

10. The one or more non-transitory machine-readable information storage mediums of claim 9, wherein the left-over memory capacity is determined based on the available memory and the current overhead.

11. The one or more non-transitory machine-readable information storage mediums of claim 9, wherein the final weighted average score of each of the plurality of worker nodes is determined as:
[W_{score}_{ᵢ}]←(Wₘ*LM(Sᵢ)+(W_{c}_{ᵢ}*AC(Sᵢ)), wherein,
W_{Scorei} is the final weighted average score, Wₘ is a weighted memory score, LM(Sᵢ) is the left-over memory capacity, W_{ci} is a weighted core score, and AC(Sᵢ) is the number of available cores, for i^{th} worker node of the plurality of worker nodes.

12. The one or more non-transitory machine-readable information storage mediums of claim 9, wherein allocating the plurality of transformer model blocks, to one or more of the plurality of worker nodes comprises of:
determining number of blocks in the transformer model, to be loaded to each of the plurality of worker nodes, based on a) the left-over memory capacity of each of the plurality of worker nodes, and b) size of each of the blocks of the data to be processed; and
loading the determined number of blocks to each of the plurality of worker nodes.
